(19) United States
(12) Patent Application Publication
(10) Pub. No.: US 2013/0280430 A1
(43) Pub. Date: Oct. 24, 2013

(54) GAS SEPARATION MEMBRANE AND METHOD OF MANUFACTURE AND USE

(71) Applicants: Chen Elizabeth Ramachandran, Houston, TX (US); Paul Jason Williams, Richmond, TX (US)

(72) Inventors: Chen Elizabeth Ramachandran, Houston, TX (US); Paul Jason Williams, Richmond, TX (US)

(21) Appl. No.: 13/978,895

(22) PCT Filed: Jan. 10, 2012
(86) PCT No.: PCT/EP12/50282

§ 371 Date: Jul. 10, 2013

Related U.S. Application Data
(60) Provisional application No. 61/431,990, filed on Jan. 12, 2011.

(51) Int. Cl. B01D 53/22

(52) U.S. Cl. CPC B01D 53/228
USPC 427/374.1; 427/397.7

(57) ABSTRACT

A method including contacting a support with a composition including an aluminum, silicon, phosphorous (SAPO) gel and/or an aluminophosphate (AlPO) gel; heating the support and the composition; and forming SAPO and/or AlPO crystals from the composition on the support; and after forming the crystals, modifying the contact between the support and the composition within a time to inhibit solubilization of a portion of the crystals. A method including seeding a support with an amount of uncalcined silicoaluminophosphate (SAPO) and/or aluminophosphate (AlPO) molecular sieve crystals; after seeding the support, contacting the support with a composition including a SAPO or AlPO gel; and heating the support and the composition to form SAPO and/or AlPO molecular sieve crystals from the gel on the support.

### BACKGROUND

1. Field

Silicoaluminophosphate (SAPO) membranes and aluminophosphate (AlPO) membranes.

2. Background Information

Natural gas is a fuel gas used extensively in the petrochemical and other chemicals businesses. Natural gas is comprised of light hydrocarbons-primarily methane, with smaller amounts of other heavier hydrocarbon gases such as ethane, propane, and butane. Natural gas may also contain some quantities of non-hydrocarbon “contaminant” components such as carbon dioxide and hydrogen sulfide, both of these components are acid gases and can be corrosive to pipelines.

Natural gas is often extracted from natural gas fields that are remote or located off-shore. Conversion of natural gas to a liquid hydrocarbon is often required to produce an economically viable product when the natural gas field from which the natural gas is produced is remotely located with no access to a gas pipeline. One method commonly used to convert natural gas to a liquid hydrocarbon is to cryogenically cool the natural gas to condense the hydrocarbons into a liquid. Another method that may be used to convert natural gas to a liquid hydrocarbon is to convert the natural gas to a synthesis gas by partial oxidation or steam reforming, and subsequently converting the synthesis gas to liquid hydrocarbons, such as that produced by a Fisher-Tropsch reaction. Synthesis gas prepared from natural gas may also be converted to a liquid hydrocarbon oxygenate such as methanol.

In a cryogenic cooling process to liquefy hydrocarbons in natural gas, carbon dioxide may crystallize when cryogenically cooling the natural gas, blocking valves and pipes used in the cooling process. Further, carbon dioxide utilizes volume in a cryogenically cooled liquid hydrocarbon/carbon dioxide mixture that would preferably be utilized only by the liquid hydrocarbon, particularly when the liquid hydrocarbon is to be transported from a remote location.

Carbon dioxide also may impair conversion of natural gas to a liquid hydrocarbon or a liquid hydrocarbon oxygenate. Significant quantities of carbon dioxide may impair conversion of natural gas to synthesis gas by either partial oxidation or by steam reforming.

As a result of the corrosive nature of carbon dioxide and the additional difficulty of processing natural gas contaminated with carbon dioxide, attempts have been made to separate carbon dioxide present in a natural gas from the hydrocarbon components of the natural gas prior to processing the natural gas to a liquid. Separation techniques include scrubbing the natural gas with a liquid chemical, e.g. an amine, to remove carbon dioxide, passing the natural gas through molecular sieves selective to separate carbon dioxide from the natural gas. These methods of separating carbon dioxide from a natural gas are effective for natural gases containing 40 percent by volume of carbon dioxide, more typically less than 15 to 30 percent by volume, but are either ineffective or commercially prohibitive in energy costs to separate carbon dioxide from natural gas when the natural gas is contaminated with larger amounts of carbon dioxide, e.g., at least 40 percent by volume.

Production of natural gas from natural gas fields containing natural gas contaminated with on the order of 50 percent by volume or more carbon dioxide is generally not undertaken due to the difficulty of producing liquid hydrocarbons or liquid hydrocarbon oxygenates from natural gas contaminated with such large quantities of carbon dioxide and the difficultly of removing carbon dioxide from the natural gas when present in such a large quantity. However, some of the largest natural gas fields discovered to date are contaminated with high levels of carbon dioxide. Therefore, there is a need for an energy efficient, effective method to separate carbon dioxide from a natural gas contaminated with carbon dioxide, including a carbon dioxide rich natural gas.

Laboratory studies of silicoaluminophosphate (SAPO) and/or aluminophosphate (AlPO) containing membranes, particularly SAPO-34 containing membranes, have demonstrated utility in separating carbon dioxide from contaminated natural gas. Formation of such membranes involves forming SAPO-34 crystals typically from a synthesis gel in and on a porous support at an elevated temperature and autogenous pressure. Forming larger scale, equivalent membranes present challenges in part because of the nature in which SAPO-34 crystals are formed and the ability to control the formation conditions.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a top perspective view of an embodiment of a silicoaluminophosphate (SAPO) membrane.

FIG. 2 is a side end view of another embodiment of a SAPO membrane.

FIG. 3 is a flow chart of a process to form a SAPO membrane.

FIG. 4 is a cross-sectional side view of a reaction vessel containing a support and a synthesis gel in a volume therein.

FIG. 5A shows a scanning electron microscope of SAPO-34 crystals.

FIG. 5B shows a scanning electron microscope of SAPO-34 crystals of FIG. 5A after the crystals were contacted with a spent synthesis gel for one hour.

### SUMMARY

In one embodiment, a method is disclosed. The method includes contacting a support with a composition including a silicoaluminophosphate (SAPO) and/or an aluminophosphate (AlPO) gel; heating the support; forming SAPO and/or AlPO crystals on the support; and after forming the crystals, modifying the contact between the support and the gel within a time to inhibit solubilization of a portion of the crystals.

In another embodiment, a method includes seeding a support with an amount of uncalcined silicoaluminophosphate (SAPO) and/or uncalcined aluminophosphate (AlPO) crystals; after seeding the support, contacting the support with a composition comprising a SAPO and/or AlPO gel; and heating the support and the composition to form SAPO and/or AlPO crystals from the SAPO and/or AlPO gel on the support and after forming the crystals, modifying the contact between the support and the gel within a time to inhibit solubilization of a portion of the crystals.

### DETAILED DESCRIPTION

In one embodiment, a commercial scale silicoaluminophosphate (SAPO) and/or aluminophosphate (AlPO) membrane having a layer or layers of SAPO and/or AlPO crystals and a method of making a commercial scale SAPO and/or AlPO membrane is disclosed. Membranes are suitable, in one embodiment, to separate components of a gas stream. Particularly, in one embodiment, a SAPO-34 membrane may be used to remove contaminants such as carbon dioxide from a natural gas stream.

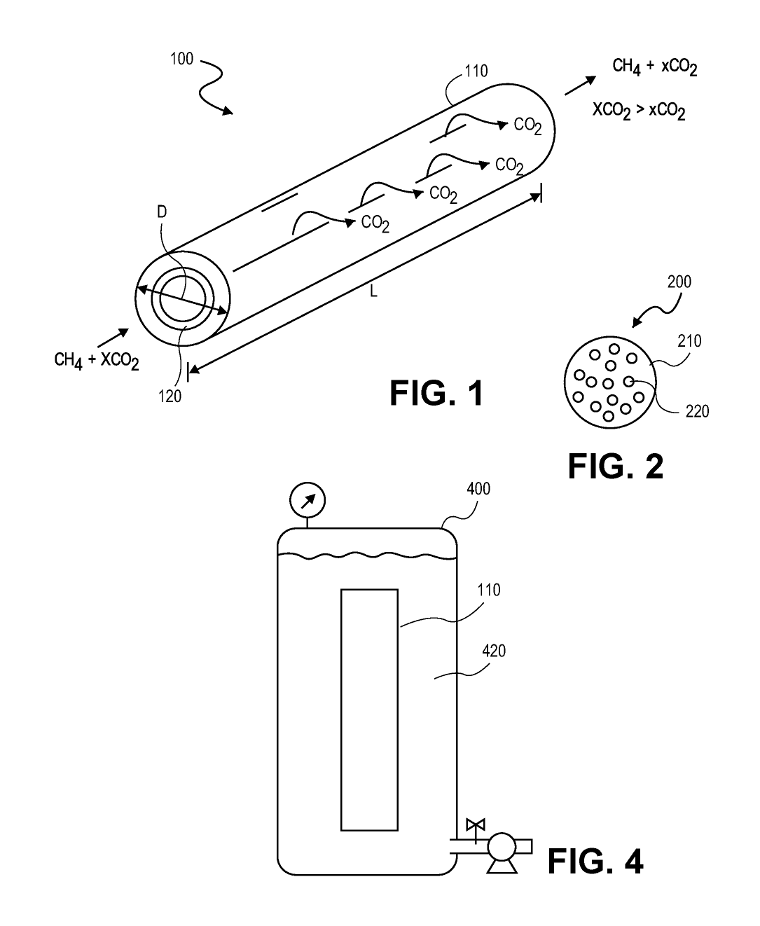

FIG. 1 shows a top, perspective view of a tubular support including a SAPO and/or AlPO material. Membrane 100 includes a support 110 that, in this embodiment, is a tube having a lumen (channel) therethrough. Support 110 is a body capable of supporting a SAPO and/or AlPO material to form a SAPO and/or AlPO membrane. In one embodiment, support 100 has a length on the order of about one meter and an outside diameter of 10 millimeters. Lengths longer or shorter than one meter and outside diameters greater than or less than 10 millimeters are also contemplated to the extent that such supports may be utilized in a commercially-viable process of, for example, separating a component or components from a gas stream. A commercially-viable process is meant to distinguish a laboratory scale experimental process where supports of lengths of, for example, several centimeters (e.g., 6 cm) may be studied.

Although a tubular structure is shown in FIG. 1, the support may be another shape suitable for the particular commercial environment, such as a flat plate or disc. The support may also be a hollow fiber support. FIG. 1 shows an embodiment of support 110 as a tubular structure with a single lumen or channel. In another embodiment, illustrated in FIG. 2, a tubular structure may have multiple lumens or channels. FIG. 2 shows membrane 200 including support 210 having multiple lumens or channels.

Referring again to FIG. 1, representatively, support 110 is a metal or an inorganic material on which SAPO and/or AlPO crystals are grown or on which a SAPO and/or AlPO material or precursor can be deposited. Suitable inorganic supports include alumina, titania, zirconia, carbon, silicon carbide, clays or silicate minerals, aerogels, supported aerogels, and supported silica, titania and zirconia. Suitable inorganic supports also include pure SAPO and/or AlPO or combinations of the previously listed materials with SAPO and/or AlPO. Suitable metal supports include, but are not limited to, stainless steel, nickel based alloy, iron chromium alloys, chromium and titanium.

In one embodiment, support 110 is comprised of an asymmetric porous ceramic material, where the layer onto which the SAPO and/or AlPO molecular sieve crystals are formed has a mean pore diameter greater than about 0.2 microns. Representative acceptable mean pore diameters for commercial application include, but are not limited to, 0.005 microns to 0.6 microns.

A support that is a metal material may be in the form of a fibrous-mesh (woven or non-woven), a combination of fibrous mesh with sintered metal particles, and sintered metal particles. In one embodiment, the metal support is formed of sintered metal particles. In another embodiment, support 110 is a porous ceramic or a porous metal hollow fiber formed from any method known in the art.

Referring to FIG. 1, a circumference of the lumen or channel of support 110 is covered with a layer or layers of SAPO and/or AlPO molecular sieve crystals. FIG. 1 shows layer 120. It is appreciated that layer 120 may represent a single layer or multiple layers. In one embodiment, layer 120 includes SAPO-34 crystals. In one embodiment, the crystals cover ideally the entire inner circumference of tubular support. A representative thickness of layer 120 is on the order of one to eight microns more preferably two to six microns.

The SAPO and/or AlPO molecular sieve crystals may embed themselves in the pores of the porous support as well as form on the support thus reducing an inner diameter of support 110. Although shown as a defined layer in FIG. 1, it is appreciated that the layer represents a continuous collection of crystals embedded in and on support 110. Referring to the embodiment shown in FIG. 2, SAPO and/or AlPO crystals 220 line the inside of the multiple channels of support 210.

FIG. 1 illustrates a use of membrane 100 including SAPO-34 crystals in and on support 110. In this illustration, a methane gas feed stream contaminated with carbon dioxide is fed into the lumen or channel of support 110 of membrane 100. Carbon dioxide in the feed stream is selectively removed from the methane gas as the gas passes through membrane 100. FIG. 1 shows carbon dioxide (CO₂) molecules being removed through support 110. The methane gas exits the lumen or channel at an end opposite an entrance of the gas feed stream. The methane gas exits membrane 100 with a reduced amount of carbon dioxide contaminant.

A membrane, such as membrane 100 in FIG. 1, is formed through hydrothermal treatment of a composition including an aqueous silicoaluminophosphate (SAPO) or aluminophosphate (AlPO) gel. In this manner, as used herein, a composition including a SAPO or AlPO gel is a composition suitable that when heated under autogeneous pressure forms SAPO and/or AlPO crystals. In one embodiment, the gel contains at least one organic templating agent. The term “templating agent” or “template” refers to a species added to a silicoaluminophosphate synthesis media to aid in and/or guide the polymerization and/or organization of the building blocks that form the crystal framework. Synthesis gels for forming SAPO and/or AlPO crystals are known to the art, but preferred gel compositions for forming membranes may differ from preferred compositions for forming loose crystals. The preferred gel composition may vary depending upon the desired crystallization temperature and time.

U.S. Pat. No. 7,316,727 describes a process of preparing a SAPO-34 synthesis gel. That process is incorporated herein in its entirety. In one embodiment, the synthesis gel is prepared by mixing sources of aluminum, phosphorus, silicon, and oxygen in the presence of templating agent and water. The composition of the mixture may be expressed in terms of the following molar ratios as: 1.0 Al₂O₃:aP₂O₅:bSiO₂:cR:dH₂O, where R is a templating agent or multiple templating agents. In one embodiment, R is a quaternary ammonium templating agent. In one embodiment, the quaternary ammonium templating agent is selected from the group consisting of tetrapropyl ammonium hydroxide (TPAOH), tetrapropyl ammonium bromide, tetrabutyl ammonium hydroxide, tetrabutyl ammonium bromide, tetraethyl ammonium hydroxide (TEAOH), tetraethyl ammonium bromide, or combinations thereof. In other embodiments, one of the templating agents may be a free amine such as dipropyl amine (DPA). In one embodiment, suitable for crystallization between about 420 K and about 500 K, a is between about 0.1 and about 1.5, b is between about 0.00 and about 1.5, c is between about 0.2 and about 10 and d is between about 10 and about 300. If other elements are to be substituted into the structural framework of the SAPO, the gel composition can also include Li₂O, BeO, MgO, CoO, FeO, MnO, ZnO, B₂O₃, Ga₂O₃, Fe₂O₃, GeO, TiO, As₂O₅ or combinations thereof.

In one embodiment suitable for crystallization of SAPO-34, c is less than about 3. In one embodiment suitable for crystallization of SAPO-34 at about 493 K for about 6 hours, a is about 1, b is about 0.3, c is about 1.2 and d is about 150. In one embodiment, R is a quaternary organic ammonium templating agent selected from the group consisting of tetrapropyl ammonium hydroxide, tetraethyl ammonium hydroxide (TEAOH), or combinations thereof.

In one embodiment, the synthesis gel is prepared by mixing sources of phosphate and alumina with water for several hours before adding the template. The mixture is then stirred before adding the source of silica. In one embodiment, the source of phosphate is phosphoric acid. Suitable phosphate sources also include organic phosphates such as triethyl phosphate, and crystalline or amorphous aluminophosphates. In one embodiment, the source of alumina is an aluminum alkoxide, such as aluminum isopropoxide. Suitable alumina sources also include aluminum hydroxides, pseudoboehmite and crystalline or amorphous aluminophosphates (gibbsite, sodium aluminate, aluminum trichloride). In one embodiment, the source of silica is a silica sol. Suitable silica sources also include fumed silica, reactive solid amorphous precipitated silica, silica gel, alkoxides of silicon (silicic acid or alkali metal silicate).

In one embodiment, the synthesis gel is aged prior to use. As used herein, an “aged” gel is a gel that is held (not used) for a specific period of time at a specific temperature after all the components of the gel are mixed together. In one embodiment, the synthesis gel is sealed and stirred during aging to prevent settling and the formation of a solid cake. Without wishing to be bound by any particular theory, it is believed that aging of the gel affects subsequent crystallization of the gel by generating nucleation sites. In general, it is believed that longer aging times lead to formation of more nucleation sites. The aging time will depend upon the aging temperature selected. Preferably, crystal precipitation is not observed during the aging period. Preferably, the viscosity of the aged gel is such that the gel is capable of penetrating pores of a porous support to which it will be contacted.

After initial mixing of the components of the synthesis gel in a container, material can settle to the bottom of the container. In one embodiment, the synthesis gel is stirred and aged until no settled material is visible at the bottom of the container and the gel appears substantially uniform to the eye. In different embodiments, the aging time at 25 C-50 C is at least about twenty-four hours, greater than about twenty-four hours, at least about forty-eight hours, and at least about seventy-two hours. For SAPO-34 membranes, in different embodiments the aging time at 25 C-50 C can be at least about forty-eight hours, at least about seventy-two hours, and between about one days and about seven days.

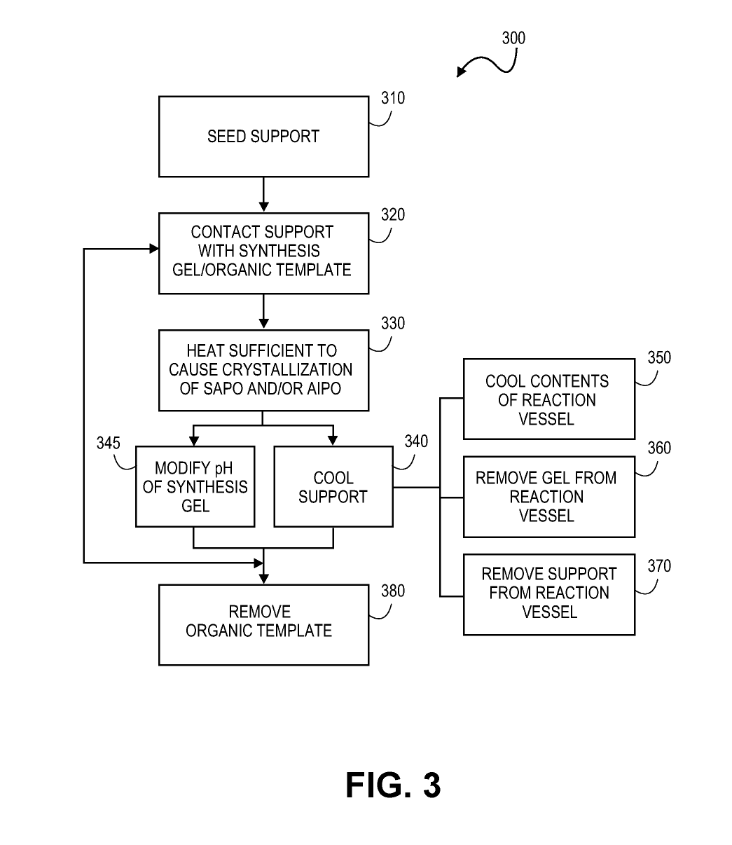

FIG. 3 presents a flow chart of a process of forming a membrane including a porous support and a layer or layers of SAPO and/or AlPO molecular sieve crystals formed in or on the support. Generally, the process includes seeding a support such as support 110 of FIG. 1 with crystals, bringing into contact the support with a SAPO/AlPO synthesis gel and heating the support and synthesis gel sufficiently to cause SAPO and/or AlPO crystals to form in and on the support. In one embodiment, porous support 110 is cleaned prior to seeding or bringing it into contact with synthesis gel. Support 110 may be cleaned in ethanol or by being boiled in purified water. After cleaning, support 110 may then be dried.

In the example of forming a tubular membrane having SAPO and/or AlPO molecular sieve crystals formed on an interior surface of a lumen or channel, a surface or surfaces of the support is contacted with SAPO and/or AlPO molecular sieve crystals (block 310, FIG. 3). This so called “seeding step” can be performed by any method known to those skilled in the art. U.S. Published Application 2007/0265484 refers to a method in which the surface of the support is coated by rubbing a dry powder onto the surface. U.S. Patent Application No. 61/310,491, filed Mar. 4, 2010, and incorporated herein by reference, refers to a method utilizing capillary depth infiltration whereby the support is contacted with a suspension of SAPO crystals. Capillary forces draw the crystals onto the surface and into the pores of the support. The support is then dried to remove the liquid, leaving the SAPO or AlPO crystals.

Seeding a porous support with SAPO and/or AlPO molecular sieve crystals provides a location for subsequent nucleation of SAPO and/or AlPO material (i.e., further crystal growth). In one embodiment, the SAPO and/or ALPO molecular sieve crystals have been previously subjected to a heating or calcining step. In another embodiment, uncalcined crystals (seeds) of SAPO and/or AlPO (e.g., SAPO-34) may be used. Typically, formation of SAPO-34 crystals involves heating at high temperature to drive off templating agents and provide a porous crystal. Calcination often involves temperatures of 400° C. (673 K) for six hours or more. In the use of SAPO crystals as a seed material, it has been found that such crystals do not need to be calcined to effectively function (e.g., as nucleation sites for further crystalline growth).

After the inner surface of the support has been seeded with crystals, to protect the outer surface or circumference of a tubular support from interaction with the synthesis gel, the tubular support is wrapped with a sacrificial material that is inert to the synthesis gel. One representative material for a sacrificial material is polytetrafluoroethylene or TEFLON®, a registered trademark of E.I. Dupont de Nemours and Company of Wilmington, Del.

Following any protection of a surface of a support, the aged synthesis gel is brought into contact with at least one surface of the support (block 320, FIG. 3). In one embodiment, the support may be immersed in the gel. FIG. 4 illustrates tubular support 110 (FIG. 1) immersed in synthesis gel 420 in reaction vessel 400. FIG. 4 shows a single support in reaction vessel 400. It is appreciated that reaction vessel 400 may have an interior volume to accommodate several supports at one time. In one embodiment, reaction vessel is sealed. As illustrated in FIG. 4, in one embodiment, support 110 is brought into contact with a sufficient quantity of gel such that growth of the SAPO and/or AlPO membrane is not substantially limited by the amount of gel available. In one embodiment, at least some of the gel penetrates the pores of the support. The pores of the support need not be completely filled with gel.

Support 110 and the aged synthesis gel are brought into contact in reaction chamber 400. Support 110 and gel 420 are heated in a SAPO and/or AlPO crystal synthesis operation (block 330, FIG. 3). The synthesis operation leads to formation of SAPO and/or AlPO molecular sieve crystals on support 110. In one embodiment, the synthesis temperature is between about 420 K and about 520 K. In different embodiments, the synthesis temperature is between about 450 K and about 510 K, or between about 465 K and about 500 K. In one embodiment, the crystallization time is between about three hours and about 24 hours but in a different embodiment, the crystallization time is about 3-6 hours. Synthesis typically occurs under autogenous pressure. In other words, reaction vessel 400 is sealed and the heating of synthesis gel 420 and support 110 results in a pressure build up within a volume of reaction vessel 400.

In one embodiment, following the formation of a desired crystalline layer in/on support 110 to form membrane 100 (support 110 including SAPO and/or AlPO molecular sieve crystals), solubilization of the crystals is inhibited by modifying the contact between the support and the synthesis gel. It has been determined that, at least at a commercial processing scale, SAPO and/or AlPO crystals (e.g., SAPO-34 crystals) tend to be soluble in the depleted synthesis gel at temperatures lower than the crystallization temperature. If exposed to this gel for an extended period of time, the crystals that form the SAPO membrane dissolve which can lead to defects in the membrane.

In one embodiment, SAPO and/or AlPO crystals in/on membrane 100 are inhibited from solubilizing by cooling the membrane as rapidly as possible (block 340, FIG. 3) and separating the membrane from the depleted synthesis gel. Rapid cooling in this regard is cooling at a rate of 323 K to 523 K per hour or faster. Rapid cooling is accomplished within four hours of completion of the desired SAPO and/or AlPO crystal layer formation.

There are a number of ways to rapidly cool a SAPO and/or AlPO membrane. In one embodiment, membrane 100 and synthesis gel 420 are cooled in reaction vessel 400 as fast as possible (block 350, FIG. 3). This cooling may be achieved by the addition of water or other cooling liquid into reaction vessel 400. In such case, reaction vessel 400 may have an interior volume sufficient to accommodate sufficient cooling liquid to accomplish rapid cooling with the membrane(s) and the gel or have a valve to allow the release of some excess volume or there is a secondary vessel to which the cooling liquid flows.

An alternative method to cool a membrane including SAPO and/or AlPO crystals is to remove synthesis gel 420 from the reaction vessel immediately following the synthesis (block 360, FIG. 3). Representatively, synthesis gel 420 may be pumped from reaction vessel 400 to rapidly remove it. The membrane may then be immediately washed in situ with cooling liquid such as water (e.g., pressurized cooling water) or low-pressure steam (e.g., steam at a pressure in the range of 0-450 psig). During the wash, excess gel remaining on the membrane can be removed from the membrane surface. After the wash is completed, reaction vessel 400 may be cooled and the membrane(s) removed.

As an alternative to the cooling method where the synthesis gel 420 is initially removed from reaction vessel 400, the membrane may be removed from the vessel immediately following a formation of a sufficient SAPO and/or AlPO membrane layer (block 370, FIG. 3). In such case, the cooling (with cool liquid or low-pressure steam) of a membrane may be accomplished outside of reaction vessel 400.

Rather than cooling a membrane including SAPO and/or AlPO crystals to inhibit solubilization of the crystals, in another embodiment, the pH of synthesis gel 420 is modified following the formation of the SAPO and/or AlPO membrane layer (block 345, FIG. 3). It has been determined that following the crystallization process, a pH of the gel or spent liquor reaches a pH of 9-11. SAPO and/or AlPO crystals tend to be more soluble at this elevated pH. By lowering the pH of synthesis gel 420, the tendency of SAPO and/or AlPO crystals to solubilize is reduced. Thus, in one embodiment, the pH of synthesis gel 420 is reduced following formation of a SAPO and/or AlPO crystal layer in/on support 110. Representatively, the pH is reduced to a neutral pH (e.g., pH=7) or lower by the addition of a pH reducing agent, for example, an acid. In one embodiment, a reducing agent is water in a sufficient amount to reduce the pH, which amount may not be sufficient to cool a membrane as described above.

In one embodiment, following the formation of a SAPO and/or AlPO membrane having a SAPO and/or AlPO layer in/on a support, additional SAPO and/or AlPO crystals may be added to the membrane. In this embodiment, the process operations illustrated in block 320 through block 340 or block 345 of FIG. 3 may be repeated.

After SAPO crystal synthesis is complete and the membrane cooled, the SAPO and/or AlPO membrane is calcined in air or an inert gas such as nitrogen or in a partial vacuum to substantially remove the organic template(s). In different embodiments, the calcination temperature is between about 600 K and about 900 K, and between about 623 K and about 773 K. For membranes made using TEAOH or TPAOH as a templating agent, the calcining temperature can be between about 600 K and about 725 K. In one embodiment, the calcination time is between about 4 hours and about 25 hours. Longer times or higher inert gas flow rates may be required at lower temperatures in order to substantially remove the template material. Use of lower calcining temperatures can reduce the formation of calcining-related defects in the membrane. The heating rate during calcination should be slow enough to limit formation of defects such as cracks. In one embodiment, the heating rate is less than about 5.0 K/min. In a different embodiment, the heating rate is about 0.6 K/min. Similarly, the cooling rate must be sufficiently slow to limit membrane defect formation. In one embodiment, the cooling rate is less than about 2.0 K/min. In a different embodiment, the cooling rate is about 0.9 K/min. After calcination, the membrane becomes a semi-permeable barrier between two phases that is capable of restricting the movement of molecules across it in a very specific manner.

### Example 1

A scaled example of forming a SAPO membrane on six centimeter membranes was performed. An asymmetric alpha alumina support (200 nm average pore size on the internal surface) was placed in a silicoaluminophosphate-forming synthesis solution or gel with the following synthesis gel composition:

1Al₂O₃:1P₂O₅:0.3SiO₂:1.0TEAOH:1.6DPA:150H₂O

The support, gel, and reaction vessel were placed in an oven set at 220° C. for six hours. A continuous SAPO-34 membrane layer was formed on the alpha alumina support. Following the formation of the SAPO-34 membrane layer, the membranes were cooled to room temperature over a period of approximately two hours and then allowed to sit in the gel before removal from the spent synthesis solution. The results show the selectivity of the resulting membranes decreases relative to a membrane's exposure time to the spent synthesis solution. The time listed is the total time exposed including the time to cool down. In the first experiment, the membrane was rapidly cooled using an ice water bath and removed from the gel. As shown in the following table, a decrease in permeance and selectivity is noticed in membranes exposed to the gel for 4 hours. A complete loss in selectivity is observed with membranes exposed to the spent synthesis solution for 12 hours. Additional research indicated similar results with longer membranes.

TABLE

| | CO₂ permeance × 10⁷ | |
|---|---|---|
| Time exposed to spent gel | [mol/m² · s · Pa] | CO₂/CH₄ |
| (h) | 4.6 MPa pressure drop | Selectivity |
| 0.25 | 8.2 | 55 |
| 4 | 4.8 | 42 |
| 12 | <<10 | 1 |
| 16 | <<10 | 1 |

### Example 2

An example of dissolution or etching of SAPO-34 crystals after extended contact with the spent synthesis gel from hydrothermal synthesis is described.

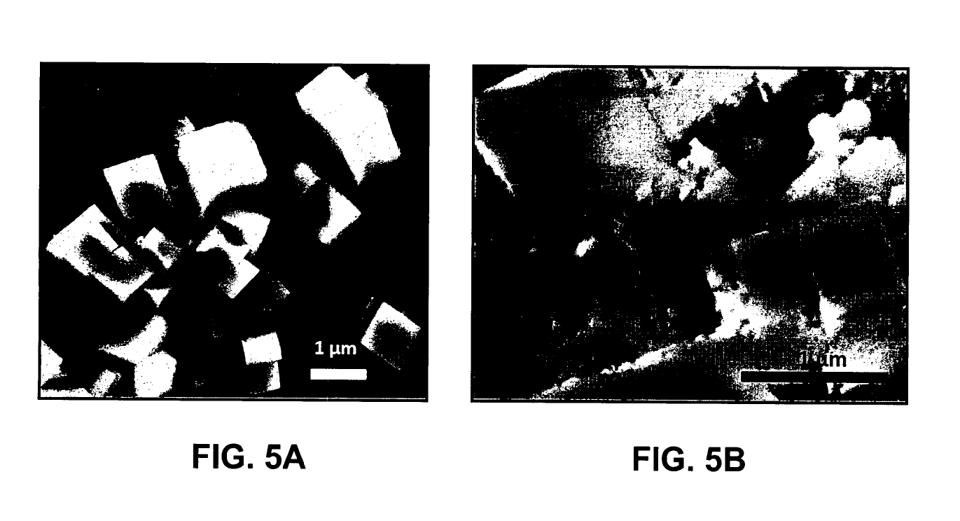

A spent synthesis gel and free SAPO-34 crystals formed after the synthesis of a SAPO-34 membrane on an asymmetric alpha alumina support (200 nm average pore size on the internal surface) were collected after the synthesis. The composition of the synthesis gel and the conditions under which it was subjected is described in Example 1. The SAPO-34 containing spent synthesis gel was then filtered to yield SAPO-34 crystals in the size range of 2-5 microns as well as a filtrate that is now referred to as the spent synthesis gel. Spent synthesis gel has a pH value typically between 9 to 11. The SAPO-34 crystals collected from the filtration were calcined for 4 hours at 400 C in nitrogen with a heating ramp of 1 C/min. Subsequently, the SAPO-34 crystals were contacted with the spent synthesis gel for a period of 1 hour. The crystals were then rinsed with deionized water and characterized by scanning electron microscopy. FIGS. 5A and 5B show the scanning electron microscope (SEM) images of representative crystals before (FIG. 5A) and after (FIG. 5B) the 1 hour soak. As can be seen, etching or dissolution of the SAPO-34 occurred during the extended contact with the spent synthesis gel.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A method comprising:
contacting a support with a composition comprising an aluminum, silicon, phosphorous (SAPO) gel and/or an aluminophosphate (AlPO) gel;
heating the support and the composition; and
forming SAPO and/or AlPO crystals from the composition on the support; and
after forming the crystals, modifying the contact between the support and the composition within a time to inhibit solubilization of a portion of the crystals.

2. The method of claim 1, wherein modifying comprises cooling the support.

3. The method of claim 2, wherein cooling comprising cooling at a rate of 50° C. to 250° C. per hour.

4. The method of claim 2, wherein contacting comprises placing the support and the composition in a reaction vessel and cooling comprises removing the support from the reaction vessel.

5. The method of claim 2, wherein contacting comprises placing the support and the composition in a reaction vessel and cooling comprises removing the gel from the reaction vessel.

6. The method of claim 2, wherein contacting comprises placing the support and the composition in a reaction vessel and cooling comprises adding a coolant to the reaction vessel.

7. The method of claim 6, wherein the coolant is water.

8. The method of claim 1, wherein modifying comprises lowering the pH of the gel.

9. The method of claim 1, wherein the support is a porous support.

10. The method of claim 1, wherein the composition further comprises organic templating agent(s), the method further comprising:
after modifying, calcining the support.

11. The method of claim 1, wherein the composition comprises a SAPO molecular sieve forming gel.

12. The method of claim 11, wherein the crystals comprise SAPO-34 crystals.

13. The method of claim 1, wherein the support comprises a length of at least one meter.

14. The method of claim 1, wherein prior to contacting the support with a composition comprising a SAPO or AlPO gel, the method comprises seeding the support with SAPO or AlPO crystals.

15. The method of claim 1, wherein the crystals for seeding the support comprise uncalcined SAPO or AlPO crystals.

16. The method of claim 15, wherein the SAPO crystals are SAPO-34 crystals.

17. A method comprising:
seeding a support with an amount of uncalcined silicoaluminophosphate (SAPO) and/or aluminophosphate (AlPO) molecular sieve crystals;
after seeding the support, contacting the support with a composition comprising a SAPO or AlPO gel; and
heating the support and the composition to form SAPO and/or AlPO molecular sieve crystals from the gel on the support.

18. The method of claim 17, wherein after forming the SAPO and/or AlPO molecular sieve crystals, the method further comprising calcining the support.

19. The method of claim 18, wherein after forming the SAPO and/or AlPO crystals and prior to calcining, modifying the contact between the support and the gel within a time to inhibit solubilization of a portion of the crystals.

20. The method of claim 17, wherein the molecular sieve crystals formed on the support comprise SAPO-34 molecular sieve crystals.
